(19) United States
(12) Patent Application Publication
(10) Pub. No.: US 2024/0059828 A1
(43) Pub. Date: Feb. 22, 2024

(54) HEM FLANGE BONDING METHOD

(71) Applicant: SIKA TECHNOLOGY AG, Baar (CH)

(72) Inventors: Dominique GALLO, Adlikon bei Regensdorf (CH); Goran CAKIC, Zürich (CH); Noah MUNZINGER, Zürich (CH)

(73) Assignee: SIKA TECHNOLOGY AG, Baar (CH)

(21) Appl. No.: 18/267,157

(22) PCT Filed: Dec. 13, 2021
(86) PCT No.: PCT/EP2021/085566

§ 371 Date: Jun. 14, 2023

(30) Foreign Application Priority Data
Dec. 15, 2020 (EP) 20214241.0

(51) Int. Cl. C08G 59/26; C08G 59/50; B29C 71/02

(52) U.S. Cl. CPC C08G 59/26; C08G 59/5006; C08J 7/08; C08J 2363/02

(57) ABSTRACT

A method of producing a hem flange bond wherein the method uses a one-component thermosetting epoxy resin composition including 20-60% by weight of at least one epoxy resin A, a latent curing agent for epoxy resins B, 10-40% by weight of at least one toughness improver D, and 4-12% by weight of a room temperature solid, crystalline polyester polyol PP. This enables compositions that are suitable for spray application and are not expressed from the hem flange in the crimping operation.

### TECHNICAL FIELD

The invention relates to the field of hem flange bonds.

### Prior Art

Hem flange bonds have long been known in industrial manufacture. It is known that parts for modes of transport, such as doors, trunk hoods, tailgates, engine hoods and the like, can be manufactured from an outer panel and an inner panel by means of flange bonding. In order to ensure fixing of the flange, an adhesive is used here, which bonds the inner panel to the outer panel.

The adhesives in current use in the prior art are expressed from the hem flange on account of their consistency in the crimping operation. Adhesive residues outside the flange are not very esthetically pleasing, present a challenge in respect of the later application of sealing compounds, and therefore require an additional cleaning process to remove them.

Moreover, standard adhesives are often unsuitable for application in novel spray applications. These methods apply the adhesive to the substrate by means of nozzles as a thin jet, constantly or in the form of droplets. This permits controlled application in relation to the site of application and the amount of adhesive applied.

EP 2 134 799 discloses application of an adhesive for hem flange bonds, said adhesive preferably containing spacers, having a viscosity of >900 Pas at 25° C. and being used with the aim of reducing the formation of blisters and cracks in the hem flange bond adhesive and the resultant propensity to corrosion.

US 2008/0045670 A1 describes an epoxy adhesive for bonding of vehicle parts. The epoxy adhesive contains a polymer comprising a polyester segment, wherein the polymer is at least partly crystalline at room temperature and has a softening temperature in the range from 40 to 125° C. The purpose of the polymer is to assure washout resistance of the adhesive in the cathodic electrocoating bath without pregelation or precuring of the adhesive.

There is therefore a need for methods of hem flange bonding which are suitable for spray applications and in which no adhesive is expressed from the hem flange in the crimping operation.

### SUMMARY OF THE INVENTION

It is therefore an object of the present invention to provide a method of hem flange bonding which is suitable for spray applications and in which no adhesive is expressed from the hem flange in the crimping operation.

This object was surprisingly achieved by the method as claimed in claim 1

Further aspects of the invention are the subject of further independent claims. Particularly preferred embodiments of the invention are the subject of the dependent claims.

### WAYS OF EXECUTING THE INVENTION

The present invention relates, in a first aspect, to a method of producing a hem flange bond, comprising at least the steps of
a) applying a one-component thermosetting epoxy resin composition to an inner panel or to an outer panel;
b) contacting the one-component thermosetting epoxy resin composition with the inner panel or the outer panel;
c) crimping the outer panel around the inner panel, such that the one-component thermosetting epoxy resin composition is present within the hem flange;
d) compressing the hem flange;
e) introducing thermal energy into the one-component thermosetting epoxy resin composition.

The one-component thermosetting epoxy resin composition comprises:
20-60% by weight, based on the total weight of the one-component thermosetting epoxy resin composition, of at least one epoxy resin A having an average of more than one epoxy group per molecule, comprising at least one liquid epoxy resin A1, preferably at least one solid epoxy resin A2, and preferably at least one epoxy group-bearing reactive diluent A3, where the proportion of liquid epoxy resin A1 is 10-100% by weight, based on the total weight of epoxy resin A;
at least one latent curing agent for epoxy resins B;
10-40% by weight, especially 20-30% by weight, based on the total weight of the one-component thermosetting epoxy resin composition, of at least one toughness improver D which is selected from the group consisting of terminally blocked polyurethane polymers D1, liquid rubbers D2 and core-shell polymers D3, and is preferably terminally blocked polyurethane D1;
4-12% by weight, based on the total weight of the one-component thermosetting epoxy resin composition, of at least one room temperature solid, crystalline polyester polyol PP.

In this document, the use of the term “independently” in connection with substituents, radicals or groups should be interpreted such that the substituents, radicals or groups having the same designation in the same molecule may occur simultaneously with different meanings.

The prefix “poly” in substance names such as “polyol”, “polyisocyanate”, “polyether” or “polyamine” in the present document indicates that the respective substance, in a formal sense, contains more than one of the functional groups that occur in its name per molecule.

“Room temperature” in the present document refers to a temperature of 23° C.

The one-component thermosetting epoxy resin composition comprises 20-60% by weight, preferably 25-55% by weight, 30-55% by weight, 35-55% by weight, especially 40-50% by weight, based on the total weight of the one-component thermosetting epoxy resin composition, of at least one epoxy resin A having an average of more than one epoxy group per molecule.

The epoxy resin A comprises at least one liquid epoxy resin A1, preferably at least one solid epoxy resin A2, and preferably an epoxy group-bearing reactive diluent A3.

The epoxy resin A preferably comprises at least one liquid epoxy resin A1, at least one solid epoxy resin A2, and at least one epoxy group-bearing reactive diluent A3.

The epoxy resin A preferably consists to an extent of more than 80% by weight, especially more than 90% by weight, more than 95% by weight, more than 98% by weight, more than 99% by weight, more than 99.9%, more preferably entirely, of the at least one liquid epoxy resin A1, preferably at least one solid epoxy resin A2, and preferably at least one epoxy group-bearing reactive diluent A3.

The term “solid epoxy resin” is very well known to a person skilled in the art of epoxies and is used in contrast to “liquid epoxy resins”. The glass transition temperature of solid resins is above room temperature, meaning that they can be comminuted at room temperature to give free-flowing powders.

Preferred epoxy resins have the formula (II)

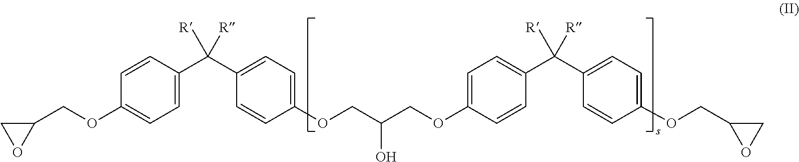

The substituents R′ and R″ here are independently either H or CH₃. In solid epoxy resins A2, the index s has a value of >1.5, especially of 2 to 12. Such solid epoxy resins A2 are commercially available, for example from Dow or Huntsman or Hexion.

Compounds of the formula (II) having an index s of 1 to 1.5 are referred to as semisolid epoxy resins by the person skilled in the art. For this present invention, they are likewise considered to be solid resins. However, preferred solid epoxy resins A2 are epoxy resins in the narrower sense, i.e. where the index s has a value of >1.5.

In liquid epoxy resins A1, the index s has a value of less than 1. Preferably, s has a value of less than 0.2.

Preference is thus given to diglycidyl ethers of bisphenol A (DGEBA), of bisphenol F, and of bisphenol A/F. Such liquid resins are available, for example, as Araldite® GY 250, Araldite® PY 304, Araldite® GY 282 (Huntsman) or D.E.R.™ 331 or D.E.R.™ 330 (Dow) or Epikote 828 (Hexion).

Further suitable epoxy resins A are what are called epoxy novolaks. These especially have the following formula:

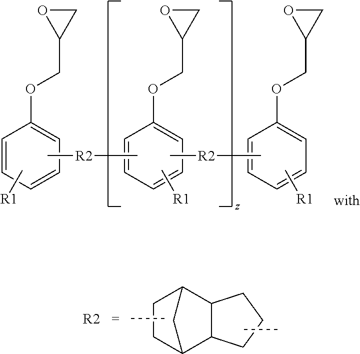

or CH₂, R1=H or methyl and z=0 to 7. In solid epoxy resins A2, the index z especially has a value of >3, especially of 3 to 7. In liquid epoxy resins A1, the index z has a value of less than 3. Preferably, z has a value of 2.2-<3. More particularly, these are phenol or cresol epoxy novolaks (R2=CH₂). Such epoxy resins are commercially available under the EPN or ECN and Tactix® trade names from Huntsman or from the D.E.N.™ product series from Dow Chemical.

More preferably, the liquid epoxy resin A1 and/or the solid epoxy resin A2 is a liquid epoxy resin of the formula (II); in particular, the two are a liquid epoxy resin of the formula (II).

The proportion of liquid epoxy resin A1 is 10-100% by weight, based on the total weight of the epoxy resin A. The proportion of liquid epoxy resin A1 is preferably 10-100% by weight, based on the total weight of the epoxy resin A, 20-100% by weight, 30-100% by weight, 30-95% by weight, 30-90% by weight, 30-80% by weight, 30-70% by weight, especially 30-60% by weight.

Advantageously, the total proportion of the liquid epoxy resin A1 is 10-50% by weight, 15-45% by weight, 15-35% by weight, preferably 15-25% by weight, based on the total weight of the epoxy resin composition.

The proportion of solid epoxy resin A2, based on the total weight of the epoxy resin A, is preferably 0-70% by weight, 10-70% by weight, 20-70% by weight, 30-70% by weight, 40-70% by weight, 40-65% by weight, especially 50-65% by weight.

Advantageously, the total proportion of the solid epoxy resin A2 is 0-35% by weight, 5-35% by weight, 10-35% by weight, 15-35% by weight, preferably 20-30% by weight, based on the total weight of the epoxy resin composition.

Preferably, the weight ratio of liquid epoxy resin A1 to solid epoxy resin A2 (A1/A2) is 0.25-3.75, especially 0.4-3.5.

This is advantageous in that this can achieve particularly high values for compressive strength with simultaneously low viscosity at 80° C. Moreover, this gives improved values for modulus of elasticity and tensile strength. This is apparent, for example, from the comparison of E2 with E4-E6 and with E7 in table 1.

It may further be advantageous when the weight ratio of liquid epoxy resin A1 to solid epoxy resin A2 (A1/A2) is 0.25-3.75, 0.4-3.5, 0.5-3.0, 0.75-2.5, especially 1.0-2.0.

This achieves the aforementioned advantages, with the particularly marked advantage here of a low viscosity at 80° C. with simultaneously high values for the other values mentioned. Moreover, this gives improved values for modulus of elasticity and tensile strength. This is apparent, for example, from the comparison of E5 with E4, E6-E7 and with E2 in table 1.

Moreover, it may be advantageous when the weight ratio of liquid epoxy resin A1 to solid epoxy resin A2 (A1/A2) is 0.25-3.75, 0.4-3.5, 0.4-3.0, 0.4-2.5, 0.4-2.0, 0.4-1.5, 0.4-1.0, especially 0.4-0.75.

This achieves the aforementioned advantages, with the particularly marked advantage here of a high modulus of elasticity, high tensile strength and high lap shear strength with simultaneously high values for the other values mentioned. This is apparent, for example, from the comparison of E6 with E4-5, E7 and with E2 in table 1.

The epoxy resin A preferably comprises an epoxy group-bearing reactive diluent A3. Such reactive diluents are known to the person skilled in the art. Preferred examples of epoxy group-bearing reactive diluents A3 are selected from the list consisting of:
glycidyl ethers of monofunctional, saturated or unsaturated, branched or unbranched, cyclic or open-chain, C₄-C₃₀ alcohols, e.g. butanol glycidyl ether, hexanol glycidyl ether, 2-ethylhexanol glycidyl ether, allyl glycidyl ether, tetrahydrofurfuryl and furfuryl glycidyl ether, trimethoxysilyl glycidyl ether;
glycidyl ethers of difunctional, saturated or unsaturated, branched or unbranched, cyclic or open-chain, C₂-C₃₀ alcohols, e.g. ethylene glycol glycidyl ether, butanediol glycidyl ether, hexanediol glycidyl ether, octanediol glycidyl ether, cyclohexanedimethanol diglycidyl ether, neopentyl glycol diglycidyl ether;
glycidyl ethers of tri- or polyfunctional, saturated or unsaturated, branched or unbranched, cyclic or open-chain, alcohols, such as epoxidized castor oil, epoxidized trimethylolpropane, epoxidized pentaerythritol or polyglycidyl ethers of aliphatic polyols, such as sorbitol, glycerol, trimethylolpropane;
glycidyl ethers of phenol compounds and aniline compounds, such as phenyl glycidyl ether, cresyl glycidyl ether, p-tert-butylphenyl glycidyl ether, nonylphenol glycidyl ether, 3-n-pentadecenyl glycidyl ether (from cashewnutshell oil), N,N-diglycidylaniline;
epoxidized amines, such as N,N-diglycidylcyclohexylamine;
epoxidized mono- or dicarboxylic acids, such as glycidyl neodecanoate, glycidyl methacrylate, glycidyl benzoate, diglycidyl phthalate, tetrahydrophthalate and hexahydrophthalate, diglycidyl esters of dimeric fatty acids; and
epoxidized di- or trifunctional, low to high molecular weight polyether polyols, such as polyethylene glycol diglycidyl ether, polypropylene glycol diglycidyl ether.

Particular preference is given to epoxy group-bearing reactive diluents A3 selected from the list consisting of hexanediol diglycidyl ether, cresyl glycidyl ether, p-tert-butylphenyl glycidyl ether, polypropylene glycol diglycidyl ether and polyethylene glycol diglycidyl ether.

The proportion of epoxy group-bearing reactive diluents A3, based on the total weight of the epoxy resin A, is preferably 0-50% by weight, 1-20% by weight, 2-10% by weight, 3-7.5% by weight, especially 4-6% by weight.

Advantageously, the total proportion of the epoxy group-bearing reactive diluent A3 is 0.1-15% by weight, preferably 0.5-5% by weight, based on the total weight of the epoxy resin composition.

The one-component thermosetting epoxy resin composition comprises 4-12% by weight, based on the total weight of the one-component thermosetting epoxy resin composition, of at least one room temperature solid, crystalline polyester polyol PP.

Compositions including less than 4% by weight of room temperature solid, crystalline polyester polyol PP have inadequate compressive strength. Compositions including more than 12% by weight of room temperature solid, crystalline polyester polymer PP have values that are too low for impact peel, and for modulus of elasticity, elongation at break, tensile strength and lap shear strength. This is apparent, for example, from the comparison of Ref.1 and Ref.5 with E1-E7 in table 1. Moreover, it is apparent by the comparison of Ref.2-Ref.4 with E1-E7 in table 1 that use of amorphous polyester for results in inadequate compressive strength.

Preferably, the proportion of at least one room temperature solid, crystalline polyester polyol PP is 5-10% by weight, 6-9% by weight, especially 7-8% by weight, based on the total weight of the one-component thermosetting epoxy resin composition.

This is advantageous in that this can achieve particularly high values for elongation at break and impact peel at 23° C. Moreover, this simultaneously assures good values for each of modulus of elasticity, tensile strength, lap shear strength, impact peel at −30° C., viscosity at 80° C., and compressive strength.

Particularly suitable room temperature solid, crystalline polyester polyols PP are polyester diols. Especially suitable polyester diols are those prepared from adipic acid, azelaic acid, sebacic acid, dodecanedicarboxylic acid, dimer fatty acid, phthalic acid, isophthalic acid and terephthalic acid as dicarboxylic acid, and from ethylene glycol, diethylene glycol, neopentyl glycol, butane-1,4-diol, hexane-1,6-diol, dimer fatty acid diol, and cyclohexane-1,4-dimethanol as dihydric alcohol. Also especially suitable are polyester diols prepared from ε-caprolactone and one of the aforementioned dihydric alcohols as starter.

Preferred room temperature solid, crystalline polyester polyols PP have a number-average molecular weight of 1500 to 9000, preferably 1500 to 6000, more preferably 2500-5000.

“Molecular weight” in the present document is understood to mean the molar mass (in grams per mole) of a molecule or part of a molecule, also referred to as a “radical”. “Molecular weight” in connection with oligomers or polymers is understood to mean the number-average Mₙ of an oligomeric or polymeric mixture of molecules, and is typically determined by means of gel permeation chromatography (GPC) against polystyrene as standard.

The room temperature solid, crystalline polyester polyol PP preferably has a melting point of 50 to 110° C., especially 70 to 95° C., more preferably 80 to 90° C. The melting point is preferably determined with a DSC instrument (DIN 53 765). The sample and an empty reference crucible are heated at a heating rate of 20° C/min. The melting point corresponds to the maximum of the melting peak.

A preferred room temperature solid, crystalline polyester polyol PP has a hydroxy value (milliequivalents of KOH per gram of polyester polyol) of 20 to 50, preferably 25 to 40, especially 25 to 35.

Moreover, preferred room temperature solid, crystalline polyester polyols PP have a hydroxy functionality of about 2, especially of 1.9 to 2.1 (average number of hydroxyl groups per polymer chain).

Commercially available room temperature solid, crystalline polyester polyols PP include Fineplus HM 3123, HM 3126 or Fineplus HM 3606 (Dic Performance Resins).

It is further advantageous when the weight ratio of epoxy resin A having an average of more than one epoxy group per molecule to room temperature solid polyester polyol PP (A/PP) is 3-15, 4-12, 4.5-10, 5-8, especially 6-7.

It may further be advantageous when the one-component epoxy resin composition includes less than 3% by weight, preferably less than 2% by weight, less than 1% by weight, less than 0.5% by weight, less than 0.2% by weight, less than 0.1% by weight, especially less than 0.05% by weight, of and especially preferably no polyester polyol which is liquid and/or amorphous at room temperature, based on the total weight of the epoxy resin composition.

The one-component thermosetting epoxy resin composition comprises at least one latent curing agent for epoxy resins B. This is preferably activated by elevated temperature, preferably at temperatures of 70° C. or more.

This is preferably a curing agent selected from the group consisting of dicyandiamide; guanamines, especially benzoguanamine; guanidines; anhydrides of polybasic carboxylic acids, especially 1-methyl-5-norbornene-2,3-dicarboxylic anhydride; dihydrazides and aminoguanidines.

The curing agent B is preferably selected from the group consisting of guanidines, especially dicyandiamide; anhydrides of polybasic carboxylic acids, especially 1-methyl-5-norbornene-2,3-dicarboxylic anhydride, and dihydrazides.

More preferably, the curing agent B is selected from the group consisting of guanidines, especially dicyandiamide, and dihydrazides.

A particularly preferred curing agent B is dicyandiamide.

The amount of the latent curing agent B for epoxy resins is advantageously 0.1-30% by weight, especially 0.2-10% by weight, preferably 1-10% by weight, especially preferably 5-10% by weight, based on the weight of the epoxy resin A.

Preferably, the thermosetting epoxy resin composition additionally contains at least one accelerator C for epoxy resins. Such accelerating curing agents are preferably substituted ureas, for example 3-(3-chloro-4-methylphenyI)-1,1-dimethylurea (chlortoluron) or phenyldimethylurea, in particular p-chlorophenyl-N, N-dimethylurea (monuron), 3-phenyl-1,1-dimethylurea (fenuron) or 3,4-dichlorophenyl-N,N-dimethylurea (diuron). In addition, it is possible to use compounds from the class of the imidazoles, such as 2-isopropylimidazole or 2-hydroxy-N-(2-(2-(2-hydroxyphenyl)-4,5-dihydroimidazol-1-yl)ethyl)benzamide, imidazolines, trihalide complexes, preferably BF₃ complexes, blocked amines and encapsulated amines.

Preferably, the accelerator C for epoxy resins is selected from the list consisting of substituted ureas, imidazoles, imidazolines and blocked amines, especially substituted ureas.

The amount of the accelerator C is advantageously 0.1-30% by weight, especially 0.2-10% by weight, preferably 1-10% by weight, especially preferably 5-10% by weight, based on the weight of the epoxy resin A.

Most preferably, the latent curing agent B is a guanidine, especially dicyandiamide, and the one-component thermosetting epoxy resin composition additionally includes an accelerator C for epoxy resins selected from the list consisting of substituted ureas and blocked amines, especially substituted ureas.

The one-component thermosetting epoxy resin composition comprises 10-40% by weight, especially 20-30% by weight, based on the total weight of the one-component thermosetting epoxy resin composition, of at least one toughness improver D which is selected from the group consisting of terminally blocked polyurethane polymers D1, liquid rubbers D2 and core-shell polymers D3.

It is preferably a terminally blocked polyurethane polymer D1, especially a polyurethane polymer D1 blocked with a blocking group that is eliminated at a temperature above 100° C.

Preferred blocking groups are especially firstly phenols or bisphenols. Preferred examples of such phenols and bisphenols are especially phenol, cresol, resorcinol, catechol, cardanol (3-pentadecenylphenol (from cashewnutshell oil)), nonylphenol, phenols that have been reacted with styrene or dicyclopentadiene, bisphenol A, bisphenol F and 2,2′-diallylbisphenol A.

The terminally blocked polyurethane prepolymer is prepared from a linear or branched polyurethane prepolymer terminated by isocyanate groups with one or more isocyanate-reactive compounds. If two or more such isocyanate-reactive compounds are used, the reaction can be effected sequentially or with a mixture of these compounds.

The reaction is preferably effected in such a way that the one or more isocyanate-reactive compounds are used stoichiometrically or in a stoichiometric excess in order to ensure that all NCO groups have been converted.

The polyurethane prepolymer with isocyanate end groups can be prepared from at least one diisocyanate or triisocyanate and from a polymer Q_{PM} having terminal amino, thiol or hydroxyl groups and/or from an optionally substituted polyphenol Q_{PP}.

Suitable diisocyanates are aliphatic, cycloaliphatic, aromatic or araliphatic diisocyanates, especially commercial products such as methylene diphenyl diisocyanate (MDI), hexamethylene diisocyanate (HDI), toluene diisocyanate (TDI), toluidine diisocyanate (TODI), isophorone diisocyanate (IPDI), trimethylhexamethylene diisocyanate (TMDI), 2,5- or 2,6-bis(isocyanatomethyl)bicyclo[2.2.1 ]heptane, naphthalene 1,5-diisocyanate (NDI), dicyclohexylmethyl diisocyanate (H₁₂MDI), p-phenylene diisocyanate (PPDI), m-tetramethylxylylene diisocyanate (TMXDI), etc. and dimers thereof. Preference is given to HDI, IPDI, MDI or TDI.

Suitable triisocyanates are trimers or biurets of aliphatic, cycloaliphatic, aromatic or araliphatic diisocyanates, especially the isocyanurates and biurets of the diisocyanates described in the previous paragraph. It is of course also possible to use suitable mixtures of di- or triisocyanates.

Especially suitable polymers Q_{PM} having terminal amino, thiol or hydroxyl groups are polymers Q_{PM} having two or three terminal amino, thiol or hydroxyl groups.

The polymers Q_{PM} advantageously have an equivalent weight of 300-6000, especially of 600-4000, preferably of 700-2200, g/equivalent of NCO-reactive groups.

Preferred polymers Q_{PM} are polyols having average molecular weights between 600 and 6000 daltons, selected from the group consisting of polyethylene glycols, polypropylene glycols, polyethylene glycol-polypropylene glycol block polymers, polybutylene glycols, hydroxyl-terminated polybutadienes, hydroxyl-terminated butadiene-acrylonitrile copolymers and mixtures thereof.

Especially preferred polymers Q_{PM} are α,ω-dihydroxy polyalkylene glycols having C₂-C₆-alkylene groups or having mixed C₂-C₆-alkylene groups, terminated by amino, thiol or, preferably, hydroxyl groups. Particular preference is given to polypropylene glycols or polybutylene glycols. Particular preference is further given to hydroxyl group-terminated polyoxybutylenes.

Especially suitable polyphenols Q_{PP} are bis-, tris- and tetraphenols. This is understood to mean not just straight phenols but optionally also substituted phenols. The nature of the substitution may be very varied. More particularly, this is understood to mean substitution directly on the aromatic ring to which the phenolic OH group is bonded. Phenols are additionally understood to mean not just monocyclic aromatics but also polycyclic or fused aromatics or heteroaromatics that have the phenolic OH group directly on the aromatic or heteroaromatic system.

In a preferred embodiment, the polyurethane prepolymer is prepared from at least one diisocyanate or triisocyanate and from a polymer Q_{PM} having terminal amino, thiol or hydroxyl groups. The polyurethane prepolymer is prepared in a manner known to the person skilled in the art of polyurethane, especially by using the diisocyanate or triisocyanate in a stoichiometric excess in relation to the amino, thiol or hydroxyl groups of the polymer Q_{PM}.

The polyurethane prepolymer having isocyanate end groups preferably has elastic character. It preferably exhibits a glass transition temperature Tg of less than 0° C.

The toughness improver D may be a liquid rubber D2. This may be, for example, a carboxy- or epoxy-terminated polymer.

In a first embodiment, this liquid rubber may be a carboxy- or epoxy-terminated acrylonitrile/butadiene copolymer or derivative thereof. Such liquid rubbers are commercially available, for example, under the Hypro/Hypox® CTBN and CTBNX and ETBN name from Emerald Performance Materials. Suitable derivatives are especially elastomer-modified prepolymers having epoxy groups, as sold commercially under the Polydis® product line, especially from the Polydis® 36. product line, by Struktol® (Schill+Seilacher Gruppe, Germany) or under the Albipox product line (Evonik, Germany).

In a second embodiment, this liquid rubber may be a polyacrylate liquid rubber which is fully miscible with liquid epoxy resins and separates to form microdroplets only in the course of curing of the epoxy resin matrix. Such polyacrylate liquid rubbers are available, for example, under the 20208-XPA name from Dow.

It is of course also possible to use mixtures of liquid rubbers, especially mixtures of carboxy- or epoxy-terminated acrylonitrile/butadiene copolymers or derivatives thereof.

The toughness improver D, in a third embodiment, may be a core-shell polymer D3. Core-shell polymers consist of an elastic core polymer and a rigid shell polymer. Particularly suitable core-shell polymers consist of a core of elastic acrylate or butadiene polymer encased by a rigid shell of a rigid thermoplastic polymer. This core-shell structure either forms spontaneously as a result of separation of a block copolymer or is defined by the conduct of the polymerization as a latex or suspension polymerization with subsequent grafting. Preferred core-shell polymers are what are called MBS polymers, which are commercially available under the Clearstrength™ trade name from Arkema, Paraloid™ from Dow or F-351™ from Zeon.

In a further preferred embodiment, the one-component thermosetting epoxy resin composition additionally comprises at least one filler F. Preference is given here to mica, talc, kaolin, wollastonite, feldspar, syenite, chlorite, bentonite, montmorillonite, calcium carbonate (precipitated or ground), dolomite, quartz, silicas (fused or precipitated), cristobalite, calcium oxide, aluminum hydroxide, magnesium oxide, hollow ceramic beads, hollow glass beads, hollow organic beads, glass beads, color pigments. Particular preference is given to fillers selected from the group consisting of calcium carbonate, calcium oxide and fumed silicas.

Advantageously, the total proportion of the overall filler F is 5-40% by weight, preferably 10-30% by weight, based on the total weight of the one-component thermosetting epoxy resin composition.

The composition may include further constituents, especially catalysts, stabilizers, especially heat and/or light stabilizers, thixotropic agents, plasticizers, solvents, mineral or organic fillers, blowing agents, dyes and pigments, anticorrosives, surfactants, defoamers and adhesion promoters.

Suitable plasticizers are especially phenol alkylsulfonates or N-butylbenzamide, as commercially available as Mesamoll® or Dellatol BBS from Bayer.

Suitable stabilizers are especially optionally substituted phenols such as BHT or Wingstay® T (Elkem), sterically hindered amines or N-oxyl compounds such as TEMPO (Evonik).

A particularly preferred one-component epoxy resin composition comprises:
10-60% by weight, preferably 25-55% by weight, 30-55% by weight, especially 40-50% by weight, based on the total weight of the epoxy resin composition, of epoxy resin A having an average of more than one epoxy group per molecule; preferably, based on the total weight of the epoxy resin A:
   the proportion of liquid epoxy resin A1 is 20-100% by weight, 30-100% by weight, 30-95% by weight, 30-90% by weight, 30-80% by weight, 30-70% by weight, especially 30-60% by weight;
   the proportion of solid epoxy resin A2 is 0-70% by weight, 10-70% by weight, 20-70% by weight, 30-70% by weight, 40-70% by weight, 40-65% by weight, especially 50-65% by weight;
   the proportion of epoxy group-bearing reactive diluents A3 is 0-50% by weight, 1-20% by weight, 2-10% by weight, 3-7.5% by weight, especially 4-6% by weight;
at least one latent curing agent for epoxy resins B, preferably selected from dicyandiamide, guanamines, guanidines, anhydrides of polybasic carboxylic acids, dihydrazides, and aminoguanidines, and derivatives thereof, preference being given to dicyandiamide;
preferably at least one accelerator C selected from the list consisting of substituted ureas, imidazoles, imidazolines and blocked amines, especially selected from the list consisting of substituted ureas and blocked amines, especially preferably substituted ureas;
at least one toughness improver D selected from the group consisting of terminally blocked polyurethane polymers D1, liquid rubbers D2 and core-shell polymers D3, preferably a terminally blocked polyurethane polymer D1, where the proportion of toughness improver D is preferably 10-40% by weight, especially 20-30% by weight, based on the total weight of the epoxy resin composition;
4-12% by weight, preferably 5-10% by weight, 6-9% by weight, especially 7-8% by weight, based on the total weight of the epoxy resin composition, of at least one room temperature solid, crystalline polyester polyol PP, preferably having a melting point of 50 to 110° C., especially 70 to 95° C., more preferably 80 to 90° C., preferably determined with a DSC instrument (DIN 53 765);
preferably 5-40% by weight, preferably 10-30% by weight, based on the total weight of the epoxy resin composition, of a filler F, preferably selected from the group consisting of wollastonite, calcium carbonate, color pigments, especially carbon black, and fumed silicas, especially color pigments, especially carbon black, and fumed silicas, more preferably fumed silicas.

Preferably, the weight ratio of liquid epoxy resin A1 to solid epoxy resin A2 (A1/A2) is 0.25-3.75, especially 0.4-3.5.

Preferably, the weight ratio of epoxy resin A having an average of more than one epoxy group per molecule to room temperature solid polyester polyol PP (A/PP) is 3-15, 4-12, 4.5-10, 5-8, especially 6-7.

It may further be advantageous when the preferred one-component epoxy resin composition consists of the aforementioned constituents to an extent of more than 80% by weight, preferably more than 90% by weight, especially more than 95% by weight, especially preferably more than 98% by weight, most preferably more than 99% by weight, based on the total weight of the epoxy resin composition.

Examples of particularly preferred compositions are, for example, E2 and E6, especially E6, in table 1.

It may further be advantageous when the compositions of the invention include less than 5% by weight, especially less than 2%, less than 1% by weight, preferably less than 0.5% by weight, more preferably less than 0.3% by weight, less than 0.2% by weight, less than 0.1% by weight, especially less than 0.05% by weight, of the following components, based on the total weight of the epoxy resin composition:
polyester polyols that are not among the aforementioned room temperature solid, crystalline polyester polyols PP and are not part of polymers, especially room temperature liquid polyester polyols and amorphous polyester polyols.

It is advantageous when the epoxy resin composition of the invention has a viscosity at 80° C. of <80 Pa*s, especially <50 Pa*s, 10-45 Pats, especially 15-40 Pa*s, preferably 15-35 Pa*s. This is advantageous in that this assures good applicability in spraying methods. Preferably, the viscosity is measured as described in the examples.

It is also advantageous when in the epoxy resin composition in the uncured state has a maximum compressive strength of >200 N, especially >250 N, 300-3000 Pa*s, especially 400-2500 Pa*s, preferably 500-2000 Pas. Preferably, the maximum compressive strength is measured as described in the examples.

Particular preference is given to thermosetting epoxy resin compositions having, in the cured state:
a lap shear strength, especially measured to DIN EN 1465, more preferably as described in the examples, of more than 15 MPa, more than 20 MPa, more than 25 MPa, and/or
a tensile strength, especially measured to DIN EN ISO 527, more preferably as described in the examples, of more than 15 MPa, more than 18 MPa, more than 20 MPa, and/or
an elongation at break, especially measured to DIN EN ISO 527, more preferably as described in the examples, of 5-70%, 8-50%, 10-40%, and/or
a modulus of elasticity, especially measured to DIN EN ISO 527, more preferably as described in the examples, of 800-1500 MPa, preferably 1000-1500 MPa, and/or
an impact peel strength at 23° C., especially measured to ISO 11343, more preferably as described in the examples, of more than 25 N/mm, more than 30 N/mm, more than 32 N/mm, and/or
an impact peel strength at −30° C., especially measured to ISO 11343, more preferably as described in the examples, of more than 5 N/mm, more than 10 N/mm, more than 15 N/mm, more than 20 N/mm.

The one-component thermosetting epoxy resin composition, in a first step (a) of the method of the invention, is applied to an inner panel or an outer panel. This is advantageously effected at the application temperature of the epoxy resin composition of 50° C. to 90° C., especially of 60° C. and 80° C., preferably of 65° C. to 75° C.

The epoxy resin composition is typically applied in the edge region of the outer panel.

The amount and exact application site of the epoxy resin composition is such that, after the compression of the hem flange described further down, the hem flange is very substantially filled with epoxy resin composition.

The application is preferably automatic.

It is further advantageous when the application is by means of spray application.

The application is preferably in the form of at least one strip, especially of essentially rectangular cross section. The strip preferably has the following dimensions:
a length of 1-100 cm, especially 5-50 cm,
a thickness of 0.2-2 mm, especially 0.3-1.5 mm, 0.3-1.0 mm, more preferably 0.4-0.6 mm,
a width of 5-50 mm, especially 10-40 mm, 15-35 mm, more preferably 20-25 mm.

The application is preferably not in the form of an adhesive bead.

In a second step (b) of the method of the invention, the epoxy resin composition is then contacted with the inner panel or the outer panel. This means that inner panel and outer panel are then in contact with the epoxy resin composition.

It is of course also possible that multiple inner panels that are bonded to one another with repetition of steps a) and b) can be used for the production of a hem flange.

In a third step (c) of the method of the invention, the outer panel is crimped around the inner panel, such that epoxy resin composition is present within the hem flange thus formed.

In a fourth step (d) of the method of the invention, the hem flange is then compressed.

Preferably, in step d), the epoxy resin in the hem flange is compressed to an epoxy resin composition thickness (dx) corresponding to 100-50%, especially 100-60%, 100-70%, especially 90-80%, of the thickness (dy) of the epoxy resin composition applied in step a).

Preferably, the epoxy resin composition thickness (dx) is 0.2-2 mm, especially 0.3-1.5 mm, 0.3-1.0 mm, more preferably 0.4-0.6 mm.

Preferably, in step d) no epoxy resin composition is expressed from the hem flange seam.

Suitable inner panels and outer panels are in principle any of the panels known to the person skilled in the art. In particular, they are those sheet metal materials that are utilized for hem flange bonding directly in the building of modes of transport or in the production of white goods.

Preferred sheet metals are made of steel, especially electrolytically galvanized, hot-dip-galvanized or oiled steel, Bonazinc-coated steel, and post-phosphated steel, and also aluminum, especially in the variants which typically occur in automobile construction.

The crimping and compressing are affected with tools known to the person skilled in the art.

In a further step (e) of the method of the invention, thermal energy is introduced into the epoxy resin composition. The supplying of thermal energy brings about the crosslinking of the one-component thermosetting epoxy resin composition, or accelerates the crosslinking thereof, so as to achieve a sufficiently high strength of the hem flange bond as quickly as possible.

Thus, step e) is preferably followed by a step f) of crosslinking the epoxy resin composition.

In a particularly preferred embodiment, the step of compressing (d) or the step of introducing thermal energy (e) is followed by a step (g) of sealing the hem flanged seam by means of a sealant. The sealant firstly has the function of giving the hem flange seam an optically clean look, since it is visible in many cases, and secondly of sealing the seam. It is preferable that as few air bubbles as possible are present in the hem flange and the interspace between the outer panel and inner panel is very substantially filled with epoxy resin composition and/or sealant.

Sealants used for the sealing of the hem flange seam may be sealants that are already known. In one embodiment, the sealant may be precured, or fully cured, by UV light. In a further embodiment, the sealant is likewise crosslinked, or accelerated, via the supply of thermal energy. Thus, step g) is advantageously followed by a further step (h) of introducing thermal energy into the sealant.

Suitable sealants are one-component sealants that are heat- or UV-curing, or room temperature-curing or -precuring two-component epoxy resin or polyurethane or (meth)acrylate sealants or vulcanizable rubber sealants. What is important in the case of these sealants is that they efficiently fulfill their sealing function and are advantageously elastic.

It has been found to be particularly preferable when the sealant is crosslinked together with the epoxy resin composition by thermal energy. The thermal energy is especially introduced into the epoxy resin composition via infrared radiation or induction heating.

It is advantageous when the introduction of thermal energy heats up one-component thermosetting epoxy resin composition to a temperature of 100-220° C., preferably 120-200° C.

The ultimate crosslinking can also be effected in a cathodic electrocoating oven.

A further aspect of the invention relates to a hem flange bond that has been produced by the method described above.

The invention further relates to the use of the above-described method of producing hem flange bonds in the production of modes of transport, especially of automobiles, buses, trucks, rail vehicles, ships or aircraft, or white goods, especially washing machines, tumble driers or dishwashers.

A further aspect of the invention relates to a hem flange-bonded composite which a crimped outer panel, an inner panel and a crosslinked one-component thermosetting epoxy resin composition as described above, disposed between the unbent inner flank of the outer panel and the inner panel.

What is finally claimed, in a further aspect of the invention, is an article including a hem flange bond as described.

Such articles or hem flange-bonded composites are especially modes of transport, especially an automobile, bus, truck, rail vehicle, ship or aircraft, or a white good, especially a washing machine, tumble drier or dishwasher.

### EXAMPLES

Adduced hereinafter are some examples which further illustrate the invention, but which are not intended to restrict the scope of the invention in any way.

Preparation of a toughness improver (“D-1”) 150 g of poly-THF 2000 (OH number 57 mg/g KOH) and 150 of Liquiflex H (OH number 46 mg/g KOH) were dried under reduced pressure at 105° C. for 30 minutes. Once the temperature had been reduced to 90° C., 61.5 g of IPDI and 0.14 g of dibutyltin dilaurate were added. The reaction was carried out under reduced pressure at 90° C. until the NCO content was constant at 3.10% after 2.0 h (calculated NCO content: 3.15%). Subsequently, 96.1 g of cardanol was added as blocking agent. Stirring was continued at 105° C. under vacuum until it was no longer possible to detect any free NCO. The product was used as such as toughness improver D-1.

| | |
|---|---|
| A-Liquid resin | liquid epoxy resin, D.E.R. 331 (bisphenol A diglycidyl ether), Dow |
| A-Solid resin | solid epoxy resin (bisphenol A diglycidyl ether-based), Dow |
| Reactive | Reactive diluent, hexanediol glycidyl ether, Denacol EX-212, |
| diluent | Nagase America |
| Dynacol 7130 | Amorphous polyester polyol, Dynacol 7130, Evonik |
| Dynacol 7150 | Amorphous polyester polyol, Dynacol 7150, Evonik |
| Fineplus HM | Room temperature solid, crystalline polyester polyol, melting point |
| 3123 | 85° C., hydroxy value 28-32, Fineplus HM 3123, Dic Performance |
| | Resins |
| Urea | N, N-dimethylurea (=1,1-dimethylurea), Sigma-Aldrich, Switzerland |
| Dicy | dicyandiamide, Dyhard 100 SF (median particle size D₅₀ of 2-3 μm), |
| | AlzChem |
| Filler | Mixture of calcium carbonate, calcium oxide, fumed silica |
| | Poly-THF 2000 (difunctional polybutylene glycol) |
| | (OH equivalent weight = about 1000 g/OH equivalent), BASF |
| | Liquiflex H (hydroxyl-terminated polybutadiene) |
| | (OH equivalent weight = about 1230 g/OH equivalent), Krahn |
| | Isophorone diisocyanate (= ″IPDI″), Evonik |
| | Cardolite NC-700 (cardanol, meta-substituted alkenylmonophenol), |
| | Cardolite |

Raw materials used.

Production of the compositions

The reference compositions Ref. 1-Ref.5 and the inventive compositions E1 to E7 were produced according to the figures in table 1. The stated amounts in table 1 are in parts by weight.

### TEST METHODS

Tensile strength (ZF), elongation at break and modulus of elasticity (DIN EN ISO 527)

An adhesive sample was pressed between two Teflon papers to a layer thickness of 2 mm. After curing at 175° C. for 35 min, the Teflon papers were removed and the specimens were die-cut to the DIN standard. The test specimens were examined under standard climatic conditions at a strain rate of 2 mm/min. Tensile strength (ZF), elongation at break and the 0.05-0.25% modulus of elasticity were measured to DIN EN ISO 527.

Lap shear strength (DIN EN 1465)

Cleaned test specimens of Elo H420 steel (thickness 1.5 mm) that had been reoiled with Anticorit PL 3802-39S were bonded with the adhesive over a bonding area of 25×10 mm with glass beads as spacer in a layer thickness of 0.3 mm, and cured at oven temperature 140° C. for 10 min.

Lap shear strength was determined on a tensile tester at a strain rate of 10 mm/min in a triple determination to DIN EN 1465.

Impact peel strength (Impact peel) (to ISO 11343)

The specimens were produced with the adhesive and DC04+ZE steel with dimensions of 90×20×0.8 mm. The bonding area here was 20×30 mm at a layer thickness of 0.3 mm with glass beads as spacer. The samples were cured for 10 minutes at oven temperature 140° C. Impact peel strength was measured at 23° C. (Impact Peel 23° C.) or at −30° C. (Impact Peel −30° C.) as a triple determination on a Zwick 450 impact pendulum. The impact peel strength reported is the average force in N/mm under the measurement curve from 25% to 90% to ISO11343.

### Viscosity

Viscosity measurements of the adhesives were effected 1 d after production on an Anton Paar MCR 101 rheometer by oscillation using a plate-plate geometry at a temperature of 80° C. with the following parameters: 5 Hz, measurement gap 1 mm, plate-plate diameter 25 mm, 1% deformation. The measurement is displayed in table 1 under “Viscosity 80° C.”

Maximum compressive strength

Punched-out samples of the compositions (in the uncured state) in cylindrical form (diameter 25 mm, with a thickness of 2 mm) were applied to a PVC carrier. Maximum compressive strength (in the uncured state) was measured at 23° C. with a tensile tester (Zwick with 10 kN load cell) at a compression speed of 10 mm/min in a triple determination. What was measured was the maximum force needed to compress the sample being measured from its thickness of 2 mm to a thickness of 0.4 mm.

TABLE 1

| | Ref. 1 | Ref. 2 | Ref. 3 | Ref. 4 | Ref. 5 | E1 | E2 | E3 | E4 | E5 | E6 | E7 |
|---|---|---|---|---|---|---|---|---|---|---|---|---|
| A-Liquid resin | 45 | 45 | 45 | 45 | 45 | 45 | 45 | 45 | 35 | 25 | 15 | 5 |
| A-Solid resin | | | | | | | | | 10 | 20 | 30 | 40 |
| Reactive diluent | 2.4 | 2.4 | 2.4 | 2.4 | 2.4 | 2.4 | 2.4 | 2.4 | 2.4 | 2.4 | 2.4 | 2.4 |
| D-1 | 22 | 22 | 22 | 22 | 22 | 22 | 22 | 22 | 22 | 22 | 22 | 22 |
| Dynacol 7130 | | 7.5 | | | | | | | | | | |
| Dynacol 7150 | | | 7.5 | 10 | | | | | | | | |
| Finplus HM 3123 | | | | | 2 | 5 | 7.5 | 10 | 7.5 | 7.5 | 7.5 | 7.5 |
| Fillers | 26.3 | 18.8 | 18.8 | 16.3 | 24.3 | 21.3 | 18.8 | 16.3 | 19.32 | 19.32 | 20.48 | 21 |
| Dicy | 4.1 | 4.1 | 4.1 | 4.1 | 4.1 | 4.1 | 4.1 | 4.1 | 3.6 | 3.6 | 2.5 | 2.0 |
| Urea | 0.2 | 0.2 | 0.2 | 0.2 | 0.2 | 0.2 | 0.2 | 0.2 | 0.18 | 0.18 | 0.12 | 0.1 |
| Total (% by wt.) | 100 | 100 | 100 | 100 | 100 | 100 | 100 | 100 | 100 | 100 | 100 | 100 |
| Modulus of | 1000 | 1470 | 1410 | 1430 | 1150 | 1180 | 1190 | 1250 | 1350 | 1320 | 1390 | 1290 |
| elasticity (MPa) | | | | | | | | | | | | |
| Elongation at | 9.5 | 8 | 7 | 7 | 13 | 8 | 14 | 12 | 11 | 13 | 26 | 60 |
| break (%) | | | | | | | | | | | | |
| Tensile strength | 21 | 26 | 26 | 26 | 23 | 20 | 21.5 | 21 | 22 | 22 | 24 | 21 |
| (%) | | | | | | | | | | | | |
| Lap shear strength | 29.9 | 28.1 | 28.1 | 26.8 | 28.0 | 28.7 | 25.7 | 19.1 | 24.6 | n.d. | 27.6 | 25.6 |
| H420 (MPa) | | | | | | | | | | | | |
| Impact Peel 23° C. | 32.2 | 21.7 | 21.4 | 22.9 | 33.6 | 32.1 | 34.2 | 28.6 | 27.6 | 30.5 | 33.1 | 28.6 |
| DC04 (N/mm) | | | | | | | | | | | | |
| Impact Peel −30° C. | 28.2 | 15.8 | 13.3 | 15.2 | 25.7 | 22.7 | 21.2 | 16.0 | 14.0 | n.d. | 12.8 | 6.5 |
| DC04 (N/mm) | | | | | | | | | | | | |
| Viscosity 80° C. | 35 | 20 | 21 | 25 | 26 | 24 | 16 | 16 | 19 | 30 | 40 | 74 |
| (Pas) | | | | | | | | | | | | |
| Compressive | 113 | 85 | 117 | 97 | 89 | 237 | 309 | 460 | 462 | 585 | 1303 | 1936 |
| strength (N) | | | | | | | | | | | | |
| A1/A2 ration | — | — | — | — | — | — | — | — | 3.5 | 1.75 | 0.5 | 0.125 |
| A/PP ration | — | — | — | — | 23.7 | 9.48 | 6.32 | 4.74 | 6.32 | 6.32 | 6.32 | 6.32 |

n.d. = not determined

1. A method of producing a hem flange bond, comprising at least the steps of
a) applying a one-component thermosetting epoxy resin composition to an inner panel or to an outer panel;
b) contacting the one-component thermosetting epoxy resin composition with the inner panel or the outer panel;
c) crimping the outer panel around the inner panel, such that the one-component thermosetting epoxy resin composition is present within the hem flange;
d) compressing the hem flange;
e) introducing thermal energy into the one-component thermosetting epoxy resin composition,
wherein the one-component thermosetting epoxy resin composition comprises:
20-60% by weight, based on the total weight of the one-component thermosetting epoxy resin composition, of at least one epoxy resin A having an average of more than one epoxy group per molecule, comprising at least one liquid epoxy resin A1, where the proportion of liquid epoxy resin A1 is 10-100% by weight, based on the total weight of epoxy resin A;
at least one latent curing agent for epoxy resins B;
10-40% by weight, based on the total weight of the one-component thermosetting epoxy resin composition, of at least one toughness improver D which is selected from the group consisting of terminally blocked polyurethane polymers D1, liquid rubbers D2 and core-shell polymers D3;
4-12% by weight, based on the total weight of the one-component thermosetting epoxy resin composition, of at least one room temperature solid, crystalline polyester polyol PP.

2. The method as claimed in claim 1, wherein the proportion of at least one room temperature solid, crystalline polyester polyol PP is 5-10% by weight, 6-9% by weight, based on the total weight of the one-component thermosetting epoxy resin composition.

3. The method as claimed in claim 1, wherein the room temperature solid polyester polyol PP has a melting point of 50 to 110° C.

4. The method as claimed in a claim 1, wherein the weight ratio of epoxy resin A having an average of more than one epoxy group per molecule to room temperature solid polyester polyol PP (A/PP) is 3-15, 4-12, 4.5-10, 5-8.

5. The method as claimed in claim 1, wherein the weight ratio of liquid epoxy resin A1 to solid epoxy resin A2 is 0.25-3.75.

6. The method as claimed in claim 1, wherein the weight ratio of liquid epoxy resin A1 to solid epoxy resin A2 is 0.25-3.75, 0.4-3.5, 0.5-3.0, 0.75-2.5.

7. The method as claimed in claim 1, wherein the weight ratio of liquid epoxy resin A1 to solid epoxy resin A2 is 0.25-3.75, 0.4-3.5, 0.4-3.0, 0.4-2.5, 0.4-1.0.

8. The method as claimed in claim 1, wherein the latent curing agent for epoxy resins B is selected from dicyandiamide, guanamines, guanidines, anhydrides of polybasic carboxylic acids, dihydrazides and aminoguanidines.

9. The method as claimed in claim 1, wherein the thermosetting epoxy resin composition additionally includes at least one accelerator C selected from the list consisting of substituted ureas, imidazoles, imidazolines and blocked amines.

10. The method as claimed in claim 1, wherein the thermosetting epoxy resin composition additionally includes at least one filler F, a proportion of the overall filler F being 5-40% by weight, based on the total weight of the one-component thermosetting epoxy resin composition.

11. The method as claimed in claim 1, wherein the thermosetting epoxy resin composition has a viscosity at 80° C. of <80 Pa*s.

12. The method as claimed in claim 1, wherein in step a), the application temperature of the one-component thermosetting epoxy resin composition is from 50° C. to 90° C.

13. The method as claimed in claim 1, wherein in step a), one-component thermosetting epoxy resin composition is applied by spray application.

14. A hem flange bond produced by a method as claimed in claim 1.

15. An article having a hem flange bond according to claim 14.
